(19) United States
(12) Patent Application Publication
(10) Pub. No.: US 2007/0016509 A1
(43) Pub. Date: Jan. 18, 2007

(54) Computerized transaction-based yield curve analytics

(76) Inventor: Robert P. Vogel, Montclair, NJ (US)

Correspondence Address: MORGAN & FINNEGAN, L.L.P., 3 World Financial Center, New York, NY, 10281-2101, US

(21) Appl. No.: 11/182,482

(22) Filed: Jul. 15, 2005

(51) Int. Cl. G06Q 40/00

(52) U.S. Cl. 705/37

(57) ABSTRACT

A computer aided method for establishing secondary market-relevant price for a bond issued by a corporate entity involves accessing data relating to executed secondary market trades for a bonds issued by the entity, analyzing the data using the computer to select a subset of the information based upon application of at least one specified criterion, and using the subset, establishing an entity specific yield curve for the entity so that, using a bond pricing model, an anticipated price for the bond can be calculated using a point on the established entity specific yield curve that corresponds to the bond.

### FIELD OF THE INVENTION

The present invention relates to computerized financial analysis and, more particularly, computerized analysis of data relating to over-the-counter traded, corporate-issued, fixed-income securities.

### BACKGROUND

Historically, obtaining accurate market pricing data for U.S. corporate bonds was difficult, primarily due to two factors. First, although a given corporate issuer may have dozens or even hundreds of issues of different rates and maturities outstanding at any point in time, only a small percentage of those may trade in a single day or week (the passage of time quickly renders any historical pricing information stale due to changes in the company and in the economic climate in general). Second, corporate bonds are primarily traded in an over-the-counter market, not an exchange. As a result, there has historically been far less transparency with respect to trading in corporate bonds than with, for example, stocks, futures or options.

In an effort to increase price transparency, on Jan. 23, 2001, the Securities and Exchange Commission (“SEC”) approved rules providing for reporting of secondary market transactions in certain fixed income securities for dissemination. In July of 2003, the National Association of Securities Dealers (“NASD”) instituted a mandatory system requiring its member firms to report market transactions for certain over-the-counter fixed-income securities so they could be distributed to the marketplace. This information, inter alia, is reported and distributed via the NASD's “Trade Reporting and Compliance Engines™ (TRACE).” At inception, reporting was required within 45 minutes of execution. However, the allowable reporting delay has been reduced over time and, since Jul. 1, 2005, transaction reports must be submitted within 15 minutes of the time of execution. Through this reporting process the NASD can provide, using TRACE, an intraday consolidated tape of trading in the over-the-counter, U.S. fixed-income markets—referred to as the TRACE feed. As a result, using the TRACE feed, bond sellers and buyers have an increased ability to see the most current available actual pricing for particular bond transactions for virtually all U.S. corporate bonds in a manner similar to the stock “ticker” used for equities.

However, the TRACE feed is of limited use. Bond pricing is different from common stock pricing because with common stock there is typically only one stock being traded for a given company (i.e. everyone is trading the same “thing”) and thus a current bid/ask for a given stock is applicable to all interested parties. In contrast, in the broad corporate bond market, as noted above, a given corporate issuer will have many bonds of different types (e.g. bonds of different—maturities, rates, coupons, payment schedules, call features, etc.). Thus, as to any given bond issue, a buyer may have to contact several market makers (i.e. sellers) for quotes and each particular market maker will set their own price—a price which will include a non-standard markup (“concession”) relative to the price that they will pay or paid to obtain that volume of the particular bond. Moreover, for a given bond, the market maker's price may itself be based upon a series of workout quotes between the market maker and one or more other bond sellers. Thus, a buyer “shopping the street” for a given volume of a particular bond will likely get different quotes from different sellers. In such cases, the feed of TRACE data can help a buyer understand the approximate price they should pay for a bond that has recently traded. However, unlike stocks, where the last trade can be meaningful even if the stock has not traded for some time, with bonds, the longer it has been since a particular bond issue has traded, the less meaningful the last sale becomes. As a result, watching the TRACE feed is of little help for a bond that has not traded for days, weeks, or longer and pricing becomes more difficult.

### SUMMARY OF THE INVENTION

The present invention addresses the above and makes it possible to use TRACE feed data to calculate a meaningful current anticipated price for all bonds of a corporate issuer, irrespective of whether any particular bond issue has traded that day or in the recent past.

One aspect of the invention involves a computer aided method for establishing secondary market-relevant price for a bond issued by a corporate entity. The method involves accessing data relating to executed secondary market trades for a bonds issued by the entity, analyzing the data using the computer to select a subset of the information based upon application of at least one specified criterion, and using the subset, establishing an entity specific yield curve for the entity so that, using an OAS-based bond pricing model, an anticipated price for the bond can be calculated using a point on the established entity specific yield curve that corresponds to the bond.

As a result, some implementations of the present invention can provide advantages and benefits on the buy side, particularly for institutional purchasers, because they can more accurately ascertain what the “best price” should be and, if of concern, thereby avoid overpaying for the bond and commensurately decreasing their realizable yield to maturity. On the sell side, some implementations of the present invention can provide advantages and benefits because sellers can avoid pricing themselves out of a transaction. Additionally, some implementations help make the bond market act more like an exchange, because real-time anticipated pricing for all issues of an entity, including thinly or rarely traded ones, can be obtained thereby improving transparency and economic efficiency.

Still further, portfolio managers employing active bond management strategies and arbitragers can benefit from certain implementations. Active bond management strategies and arbitrage activities rely on expectations of interest rate movements or changes in yield-spread relationships. Those using such strategies attempt to exploit factors that affect a fixed income portfolio's return, namely, changes in: the level of interest rates, the shape of the yield curve, yield spreads across or between sectors, and yield spreads for a particular instrument. Those implementations make it possible for such managers to more quickly and efficiently identify and react to such changes in an effort to increase a portfolio's return.

The above advantages and features are of representative embodiments only, and are presented only to assist in understanding the invention. It should be understood that they are not to be considered limitations on the invention as defined by the claims, or limitations on equivalents to the claims. For instance, some of these advantages may seem mutually contradictory, in that they cannot be simultaneously present in a single embodiment. Similarly, some advantages are primarily applicable to one aspect of the invention. Thus, this summary of features and advantages should not be considered dispositive in determining equivalence. Additional features and advantages of the invention will become apparent in the following description, from the drawings, and from the claims.

### BRIEF DESCRIPTION OF THE DRAWINGS

FIG. 1 is an example of yield curves for the highest rated corporate bonds across all industries;

FIG. 2 is a chart showing composite yields and rates for various grades and durations of corporate bonds;

FIG. 3 is a table of actual transaction information that occurred on Jul. 7, 2005 between 4:40:00 and 17:04:00 for a callable, 5% coupon, General Electric AAA-rated bond with a February 2012 maturity date;

FIG. 4 is a chart of the intra-day trading for the General Electric Corp. bond referred to in connection with FIG. 3 between Mar. 1, 2005 and Jul. 6, 2005;

FIG. 5 is an example plot of subsets for example bond trades for nine different bonds of a single commercial entity all having maturities falling within about an eleven year span;

FIG. 6 is a second example plot of a different set of trades for a different entity resulting from accessing TRACE feed data and processing it in the manner described in connection with FIG. 5;

FIG. 7 is a yield curve superimposed upon and derived from the plot of FIG. 5;

FIG. 8 is an entity-specific yield curve superimposed upon and derived from the plot of FIG. 6;

FIG. 9 shows how an MCAA-Yield is obtained from the yield curve of FIG. 8;

FIGS. 10A through 10D show a simplified example of a widening window approach with respect to a particular entity having a set of bond issues outstanding with yearly maturities of from one-year to fifteen-years;

FIG. 11 is a simplified example aggregating different environments in which the approach described herein can be used; and

FIG. 12 is a representative generic example of a computer suitable for implementing some variants of the approach described herein.

### DETAILED DESCRIPTION

The instant approach is explained below by way of example, first, through an introductory overview of relevant aspects of the bond market and bond trading that form the basis for the approach. Then, the approach is described in summary overview fashion. Finally, the approach is described with respect to a more commercially suitable implementation.

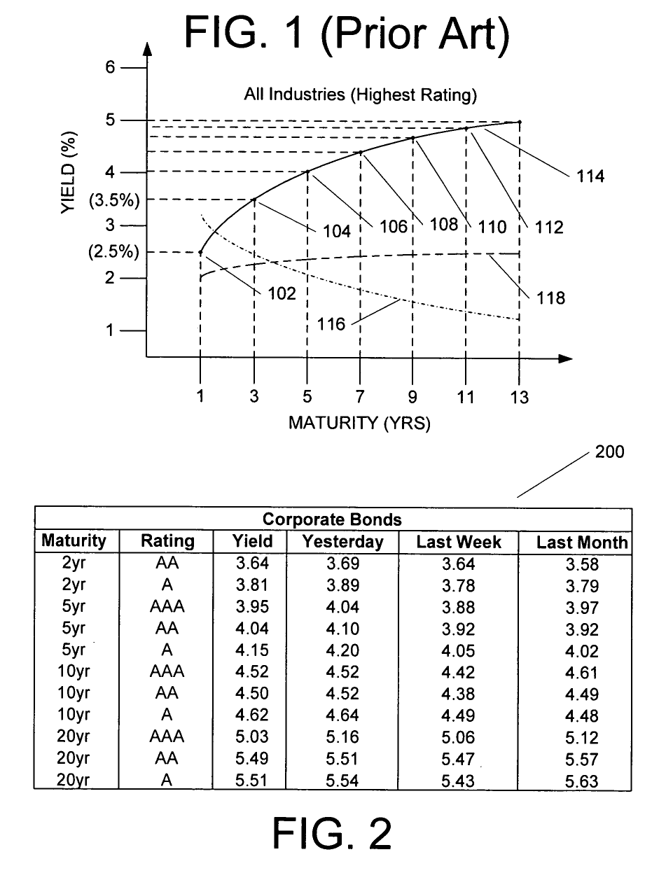

As noted above, U.S. corporations issue many different bonds (i.e. having different maturities, yields to maturities, payment dates, coupons and “call” features, etc.). As shown in simplified form in FIG. 1, if, for a given industry or bond rating class, one charts each such bond as a point (102, 104, 106, 108, 110, 112) on a graph, with yield level plotted on the vertical axis and the term to maturity of debt instruments of similar creditworthiness plotted on the horizontal axis and connects the points a yield curve (114) is created. In general, as shown in FIG. 1, the shape of the yield curve (114) usually slopes upward (a “normal” yield curve). Occasionally, however the yield curve may become “inverted” (116) to reflect that yields on longer-term bonds are lower than on short-term bonds, generally a signal that interest rates are reaching their peak and investors are anticipating lower interest rates and favoring bonds with longer maturities driving down their prices relative to the prices of bonds with shorter maturities. A flat yield curve (118) suggests that yields-to-maturity change little, regardless of maturity.

FIG. 2 is a chart (200) showing composite yields and rates for various grades and durations of corporate bonds (in this case as of Jul. 6, 2005). As should be evident from the yield variations in the chart (200) of FIG. 2, the yield curve for such bonds changes shape daily. In practice, it is known that a yield curve flattens when interest rates are at, or near, their highs. Conversely, a yield curve becomes steeper when interest rates are moving higher. In addition, a yield curve may flatten or steepen due to imbalances in the supply/demand relationship.

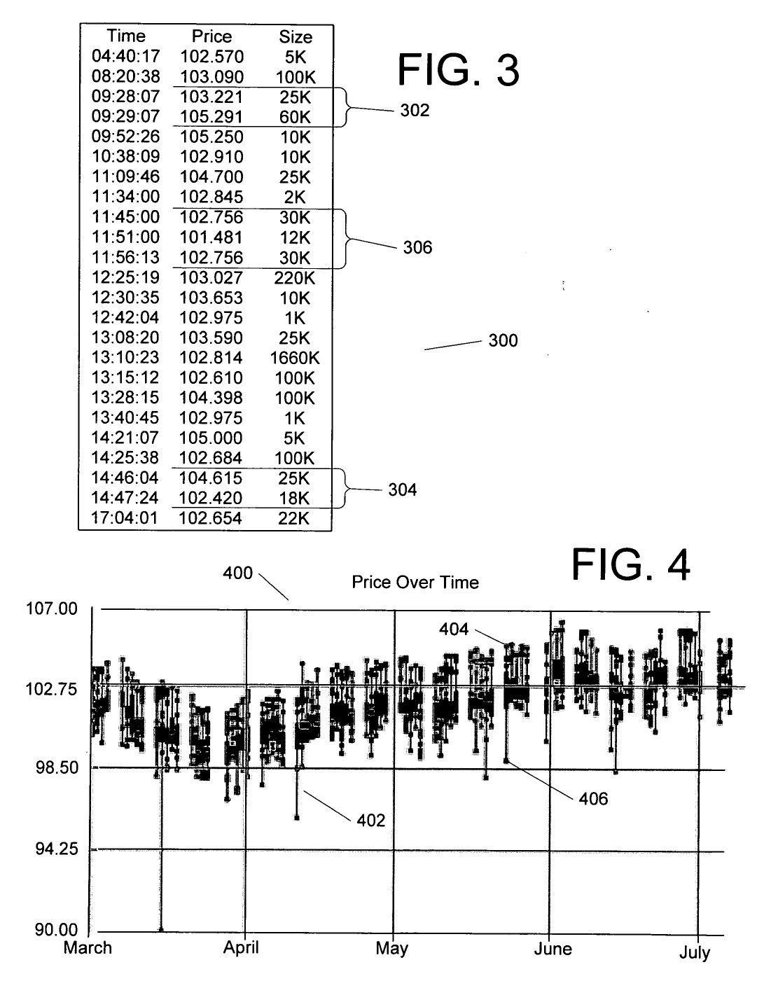

Our approach derives from the fact that, in any given day, for any particular bond issue of an entity, the number of transactions can range from zero to several hundred. Moreover, as noted above, due to the nature of the way bonds are traded the price can fluctuate wildly. This is best illustrated and understood, with reference to a representative example of actual bond transaction information. FIG. 3 is a table (300) of actual transaction information that occurred on Jul. 7, 2005 between 4:40:00 and 17:04:00 for a callable, 5% coupon, General Electric AAA-rated bond with a February 2012 maturity date. As can be readily seen, there were a total of 24 transactions and the price range spanned from 101.481 to 105.291 with the lowest volume trades (1000 units) both trading at 102.975 and the highest volume trade (1.66 million units) trading at 102.814. More notably, just before 9:30 two trades (302) transacted nearly simultaneously at a price difference of +2.070, and at about 14:45 two trades (304) transacted nearly simultaneously at a price difference of −2.195. In addition, the low trade of the day occurred at the middle of a ten minute window and was sandwiched between two identical trades (306). From the chart of FIG. 3 alone, one can readily see that it is difficult to anticipate at any given point in time what the appropriate price for that bond should be. Moreover, given the wild fluctuation for a single bond in a single day, it is more difficult to accurately price a different bond of the same entity that is not currently being traded, and even more difficult to do so if that bond has not traded for several days or more (as can often be the case). The above is visually evident from FIG. 4, which is a chart (400) of the intra-day trading for the same General Electric Corp. bond noted above between Mar. 1, 2005 and Jul. 6, 2005. The range of trades is illustrated in the form of a candle chart with a “candle” (402) representing the range of trades in each day, with the uppermost point (404) for each candle “bar” being the high price of that day and the lowermost point (406) being the low price of that day. Each such trade establishes a different actual yield to maturity for that purchaser because the stated yield is based upon par value and bonds rarely trade at par—thus a purchase above par will lower the actual yield to maturity for the purchaser and a purchase below par will increase the actual yield to maturity for the purchaser.

In summary overview, the approach accesses the TRACE feed data and analyzes it to identify all bond trades for one or more entities of interest. For a given entity of interest, the information is further analyzed and some of that information is excluded from further use based upon one or more exclusion criteria. The remaining subset of information is then used as data points for creation of an entity-specific yield curve. As a result, because it is both entity specific and based upon the most up-to-date meaningful information available the resultant yield curve reflects the current state of that entity's bonds. Moreover, that yield curve, can be used to price non-traded bonds by using the maturity date of any such non-traded bond and the yield curve to identify the most current actual anticipated yield to maturity or “MCAA-Yield” for such bond. Thereafter, the current anticipated price can be calculated in a straightforward manner by using the bond particulars, that yield curve and the corresponding MCAA-Yield in a standard Option Adjusted Spread (OAS) pricing model. Moreover, as the trading day progresses and additional trades occur, the process can be iteratively performed such that at any given point in the trading day, shifts in the yield curve can be identified and the most current anticipated pricing for every bond of that entity can be ascertained.

With the above in mind, a more detailed explanation of the approach will now be presented.

The instant approach starts by accessing a source of executed trade information, for example, the TRACE feed data for, inter alia, the entity of interest. Such data including information, inter alia, identifying the bond, the trade price, the time of the trade, the entity reporting the trade, the size or volume of the trade, etc. as set forth in the TRACE User Guide Version 1.07. Next, the actual trade data for that entity's bonds is analyzed to ascertain which of the trades satisfy at least one particular criterion so that less meaningful data can be excluded. For example, a criterion can involve separation of retail (i.e. individual) purchases from institutional purchases and exclusion of some or all of those retail trades, based upon the fact that institutional buyers routinely get better prices than retail buyers and represent the lions share of meaningful trades in any given day. Another example criterion can involve exclusion of trades of less than a particular size. Yet another example criterion is exclusion of trades of less than a particular value. Another exclusion criterion example is odd lot trades or trades from particular sellers based upon the likelihood that certain sellers may actually be middlemen who are aggregating multiple small retail trades into larger blocks for purposes of obtaining a better concession differential.

Alternatively, the exclusion can occur as part of the process of creating a yield curve specific to the entity as described below.

Based upon application of one or more such criteria, a subset of the information obtained from the TRACE feed data for the particular entity's bonds will remain.

The same thing is done for each different bond of that entity, concurrently, sequentially or piecemeal, the end result being the same. What will then remain is a subset of all of the trades for that bond and, for each bond, set of points that can be plotted on a chart of maturity versus yield.

Alternatively, in some variants, the subsets are obtained by, for each of the bonds calculating a volume weighted average of all of the trades of a given bond.

In other variants, the subsets are obtained by, for each of the bonds, calculating a volume weighted average but, prior to doing so, excluding all odd lot trades.

In yet other variants, the subsets are obtained by, for each of the bonds, calculating a time stamped volume weighted average that gives greater weight to trades having a more recent time stamp.

In still other variants, the subsets are obtained by, for each of the bonds, calculating a time window based volume weighted average in which either only those trades occurring within a specified time window are used in the weighted average calculation or a time window is set such that only the most recent “n” number of trades establish a time window for the trades used in the weighted average calculation.

In yet other variants, the subsets are obtained by, for each of the bonds, employing a statistically based calculation (weighted or unweighted).

In still other variants, the subsets are obtained by, for each of the bonds, performing a tolerance based mean trade level analysis in which two trades having different time stamps and the same or very similar sizes establish a range center point to which a specified tolerance is applied (i.e. trades within x% in size or trades within y basis points) and all trades outside of the tolerance level are excluded.

In yet other variants, the tolerance based approach described above is used, but it is modified by a time stamp consideration that gives greater weight to trades having a more recent time stamp.

In still other variants, the tolerance based approach described above is used, but it is modified by first applying a time window filter (i.e. only that information within the time window is used).

In yet other variants, permutations and combinations of the above are used.

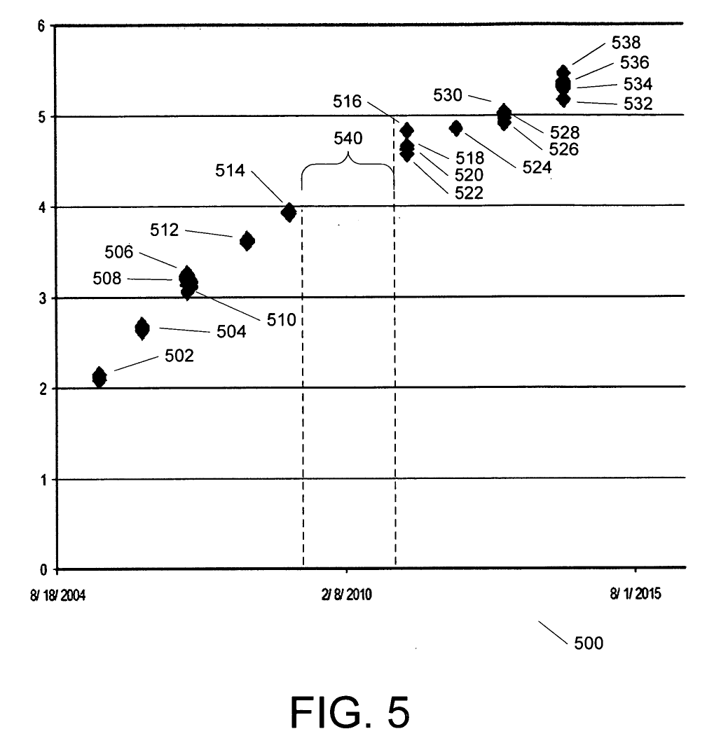

By way of example, FIG. 5 is an example plot (500) of resultant subsets of example bond trades for nine different bonds of a single commercial entity all having maturities falling within about an eleven year span. The vertically aligned points (502 thru 538) represent different trades for the same maturity bond and the location on the vertical is the calculated actual yield to if held to maturity for each purchaser based upon the particular price paid in the transaction. As can be seen from FIG. 5, there have been no trades of any bonds of that entity falling within a two-year window of time (540) roughly centered about the “Feb. 8, 2010” maturity date. Advantageously, as will be explained below, despite this absence of trades, anticipated pricing for any bond of that entity falling within that window can nevertheless be ascertained.

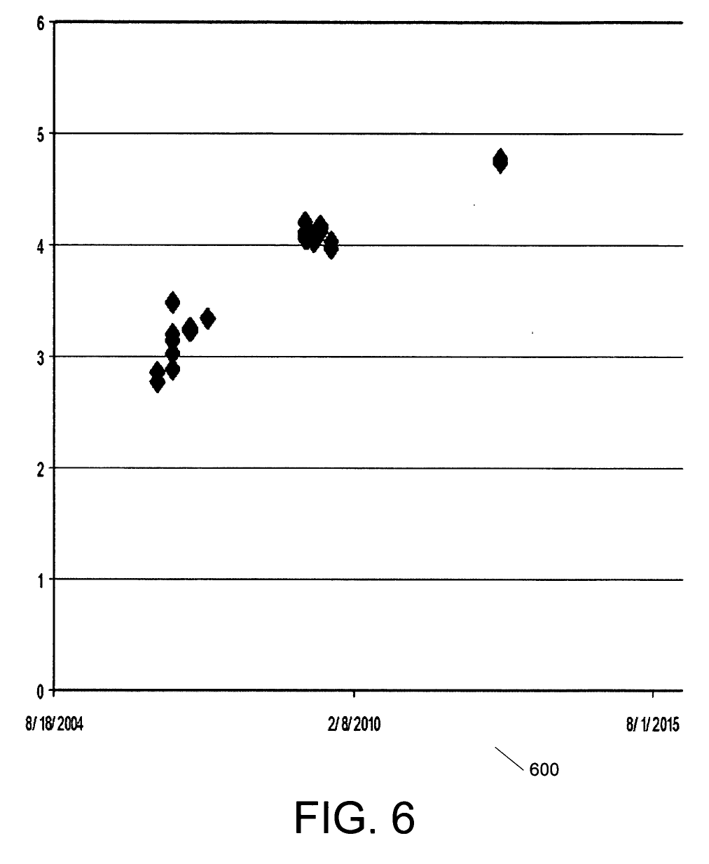

FIG. 6 is a second example plot (600) of a different set of trades for a different entity resulting from accessing TRACE feed data and processing it in the manner described in connection with FIG. 5. Notably, although the dots also identify trading in nine different bonds, the trading appears to be clustered about three discrete maturity periods. As to all other bonds having other maturity dates, no trades have occurred. As with the “gap” in FIG. 5, despite the clustering of trading, anticipated pricing for any bond of that entity falling within the other maturity “windows” can nevertheless also be ascertained.

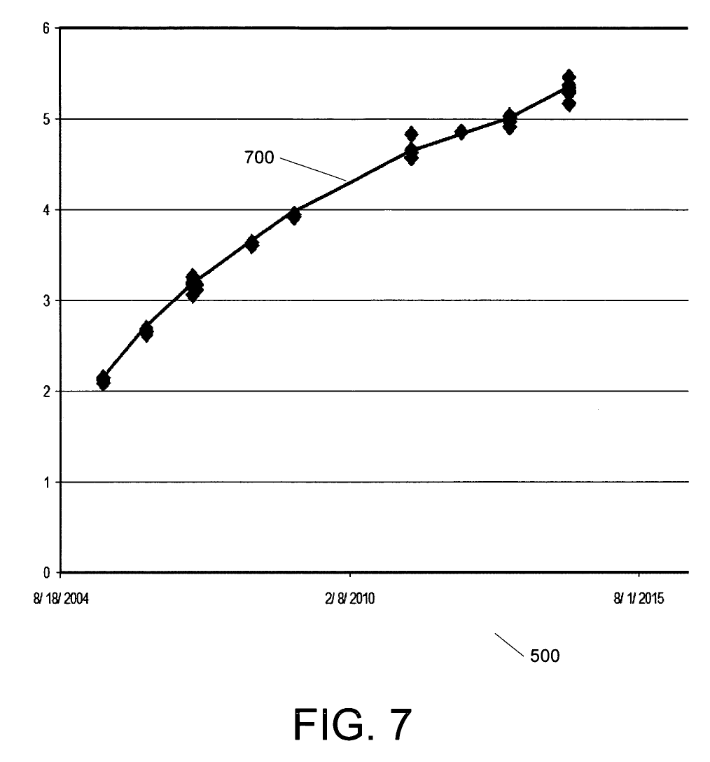

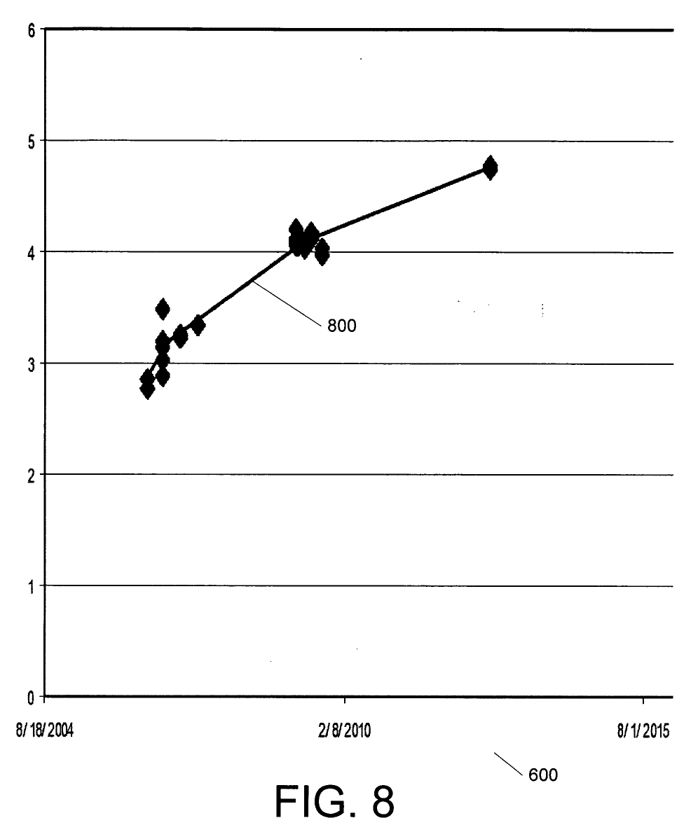

Such anticipated pricing is advantageously achieved by connecting the “dots” (i.e. the subset points) using a curve fitting technique, for example, a cubic spline fit. The resulting curve is a yield curve that is entity-specific and time specific in that it represents the most current yield curve with respect to the subset data parameters used. FIG. 7 shows just such a yield curve (700) superimposed upon and derived from the plot (500) of FIG. 5. Similarly, FIG. 8 shows an entity-specific yield curve (800) superimposed upon and derived from the plot (600) of FIG. 6.

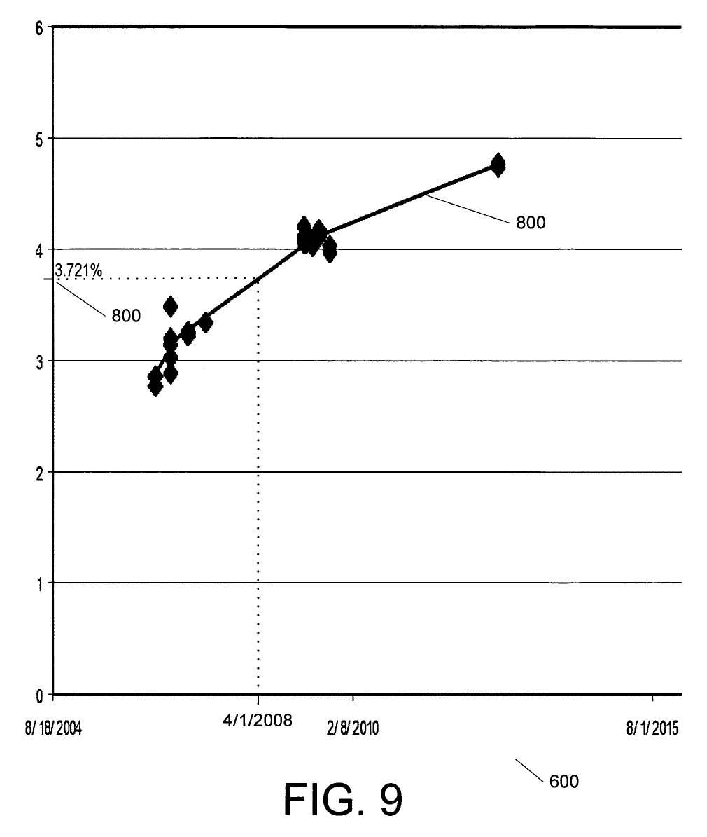

Once such a yield curve is created for the entity, a number of benefits and advantages flow directly from it. For example, assume that someone were looking for pricing on bonds of the entity of FIG. 8 having a maturity date of Apr. 1, 2008. As shown in FIG. 9, by using the yield curve (800) of FIG. 8 and the Apr. 1, 2008 maturity date, a corresponding MCAA-Yield of 3.721% is identified. The yield curve and that MCAA-Yield are then used in a standard OAS pricing model to obtain a current anticipated price for that bond—there by allowing the seller to more accurately price the bond.

Alternatively, on the buy side, assume that a prospective buyer is interested in those very same Apr. 1, 2008 bonds. Using a system applying an implementation of the approach, assume that the actual anticipated price using the OAS model calculates to 97.375. The buyer can now negotiate knowing that bonds offered at prices significantly above 97.375 are probably overpriced whereas bonds that can be obtained at less than 97.375 are probably a bargain.

Similarly, having knowledge obtainable through use of the approach the sell side can more efficiently attempt to maximize mark-ups and the buy side can better negotiate for the best deal they can get without regard to what others lacking such knowledge might be paying.

In alternative cases, for example ones that might be of interest to someone employing active bond management or bond-based arbitrage, different timing windows could be used for different purposes. For example, in one implementation a fixed size sliding (i.e. continuous) or jumping (i.e. “snapshot”) window (whether overlapping or not) of some specified time period could be used such that only TRACE feed data for the entity falling within the window will be used. In the case of the sliding time window, an entity-specific continuously varying yield curve can be generated. In the case of the jumping time window, the individual curves created from each discrete time window can be superimposed upon each other. In either case, fluctuations, shifts in steepness, temporary or partial inversions and other changes of interest can be observed and taken advantage of. Alternatively, a “widening window” can be used to similar effect, the particular time periods being more of convenience than necessity with the caveat that the window would likely never be narrower than necessary than necessary to allow for analysis and establishment of three data points (i.e. transactions for at least three different bond maturity dates).

For purposes of understanding only, by way of example, implementations using a jumping window might use a window that starts out using the pertinent transaction data subset resulting from trades occurring between about the trading start time and about mid-morning of the trading day. Thereafter, the next widow would only encompass the data reflecting trades occurring between about mid-morning and about mid-day of the trading day. The next window might encompass data reflecting trades occurring between about mid-day and about mid-afternoon of the trading day. The next window might encompass data reflecting those trades occurring between about-mid afternoon and late-afternoon of the trading day, and so forth.

Widening window implementations might use a window that starts out using the pertinent transaction data subset resulting from trades occurring between about the trading start time and about mid-morning of the trading day to establish a baseline curve. Thereafter, the window could “widen” further to encompass additional data reflecting trades occurring between about mid-morning and about mid-day of the trading day. Then, the widow could widen to add data reflecting trades occurring between about mid-day and about mid-afternoon of the trading day. Finally, the window could further widen to account for data reflecting those trades occurring between about-mid afternoon and late-afternoon of the trading day.

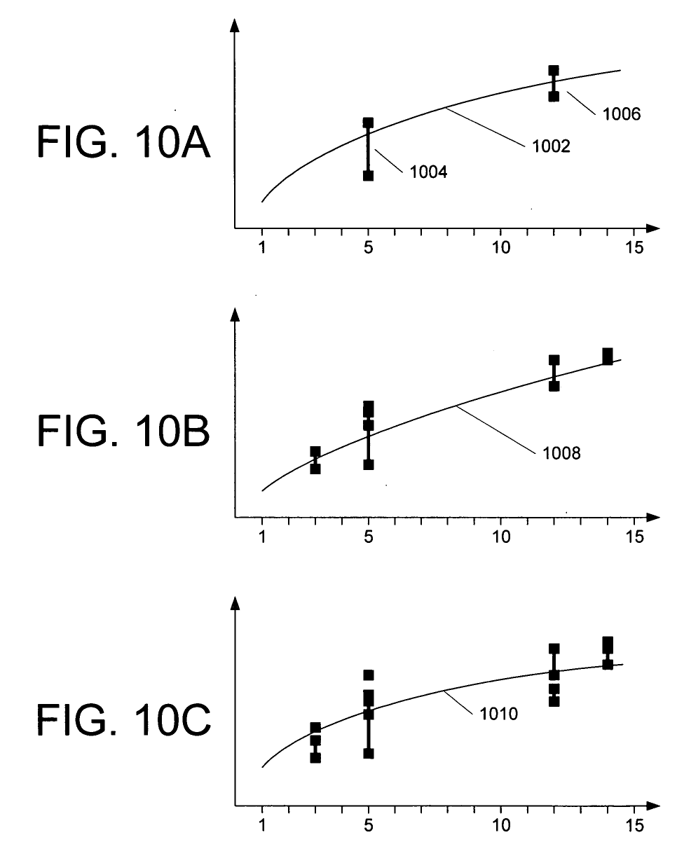

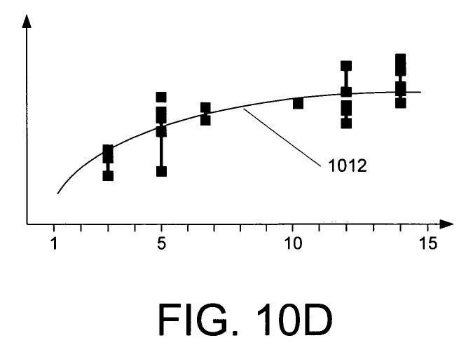

FIGS. 10A through 10D show a simplified example of a widening window approach with respect to a particular entity having a set of bond issues outstanding with yearly maturities of from one-year to fifteen-years. Specifically, FIG. 10A shows a yield curve (1002) for an example entity created as described above based upon a subset of the trades for bonds of an entity that occurred within a between about the start of the trading day and about mid-morning of that day. As shown, there was only trading in the five-year and twelve-year bonds with the “candles” (1004, 1006) illustrating the range of trading for each based upon a calculation of the yield from the price.

FIG. 10B shows a new yield curve (1008) for the same entity and day, due to addition of trades occurring within the window of from about mid-morning to about mid-day. As shown in FIG. 10B, within this time window, there have been some additional trades in the three-year, five-year and fourteen-year bonds.

FIG. 10C shows a new yield curve (1010) for the same entity and day, that takes into account trades occurring within the window of from about mid-day to about mid-afternoon. As shown in FIG. 10C, within this time window, there has been further trading in the three-year, five-year, twelve-year and fourteen-year bonds.

FIG. 10D shows a new yield curve (1012) for the same entity and day, but further takes into account trades occurring within the window of from about mid-afternoon to about late-afternoon. As shown in FIG. 10D, within this time window, there has been further trading in the three-year, twelve-year and fourteen-year bonds and new trades in the seven-year and ten-year bonds.

In general, a jumping window approach will likely be more suitable for circumstances where there is routinely a significant amount of trading of largely the same bonds of the entity within a given time window. In contrast, the widening window approach will likely be more suitable for circumstances where there is less consistency in the maturities being traded within any given window.

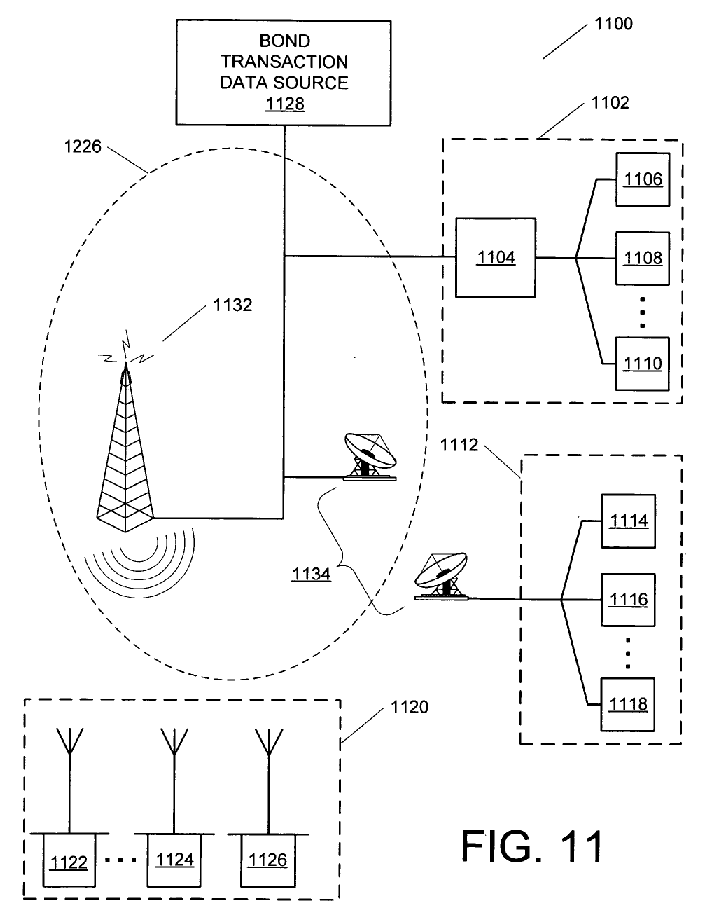

FIG. 11 is a simplified example 1100 aggregating different environments in which the above-described approach can be used. It should be understood however, that this environment description is not intended to limit the approach in any way but rather is intended to place the approach in context—none of the particular environments (or their specific implementation details) being per se critical to use of the approach, the only critical aspects being the approach itself (as embodied in suitable computer executable form) and a computer of sufficient speed, storage and processing power to be capable of receiving the relevant data and operating on it according to the pertinent implementation of the approach as conceptually described above.

One example environment (1102) is referred to as the information aggregator environment. In such an environment (1102), a centralized computer system (1104), for example a central server, mainframe or minicomputer receives bond transaction data and implements some variant of the approach described above to generate the yield curve. The centralized computer system (1104) is accessible via one or more terminals (1106, 1108, 1110) which may be located geographically near each other or may be geographically remote from each other. The terminals (1106, 1108, 1110) can be “dumb” terminals that simply interact with the centralized computer system (1104) or they can be computer systems in their own right, for example, “smart” terminals or personal computers. Depending upon the particular implementation, any given terminal might have graphical capabilities or their own programs which can take the output of the centralized computer system (1104) and permit further manipulation of that information. For example, to allow a user to perform “what if” calculations or other investment-pertinent analysis. Alternatively, with this environment (1102), the approach described above can be split up between the centralized computer system (1104) and a smart terminal (assuming it has sufficient processing capability) or personal computer. In this manner, for example, the calculation intensive work (for example, segregation of the data feed as received and/or performing curve fitting-related calculations) can be handled by the centralized computer system (1104) , with the actual pricing calculations based upon the resultant curve being performed by the individual terminal.

The second environment is referred to a the distributed environment (1112). In the distributed environment (1112), each computer (1114, 1116, 1118) has sufficient processing power and programming to receive the data feed and directly operate on it as required to implement one of the techniques described herein.

The third environment is referred to as the “unstructured” or “nontraditional” environment (1120). The unstructured or nontraditional environment (1120) is most typified by the more powerful portable devices which are themselves computers, examples being general purpose devices such as laptop computers (1122), handheld or “palm” computers (1124), or special purpose devices such as specialized bond trading communication units (1126). Such devices are deemed unstructured or non-traditional because they may be proprietary or special purpose devices or otherwise “blur the line” between computers and other devices such as, for example, cell phones, cameras or gaming systems.

Common to all environments is a mode through which preferably the most current data can be obtained from a bond transaction data source (1128), ideally as a relatively continuous stream or feed. Such a source could be a “first party” feed (i.e. from a system to which transactions are reported), like the feed from the NASD TRACE system. Alternatively, the source could be a “second party” feed (i.e. from a party who itself receives one or more first party feeds and, for example, either aggregates them or adds to/otherwise manipulates the information, or both, and retransmits). As shown, for purposes of illustration only, the connection can be via a communications network (1226) which will typically be configured to include any one or more of the following communication media: “wired” (for example, electrical wiring or optical fiber or some combination thereof) (1130) or wireless (for example, radio (1132) or satellite (1134)) or some combination thereof.

Finally, having described example environments for the application, for purposes of understanding, a brief description of various typical personal computer or server variants will be described with the understanding that, as noted above, in still other variants, supercomputer, mainframe, minicomputer, hand-held computer or other computer devices can be used.

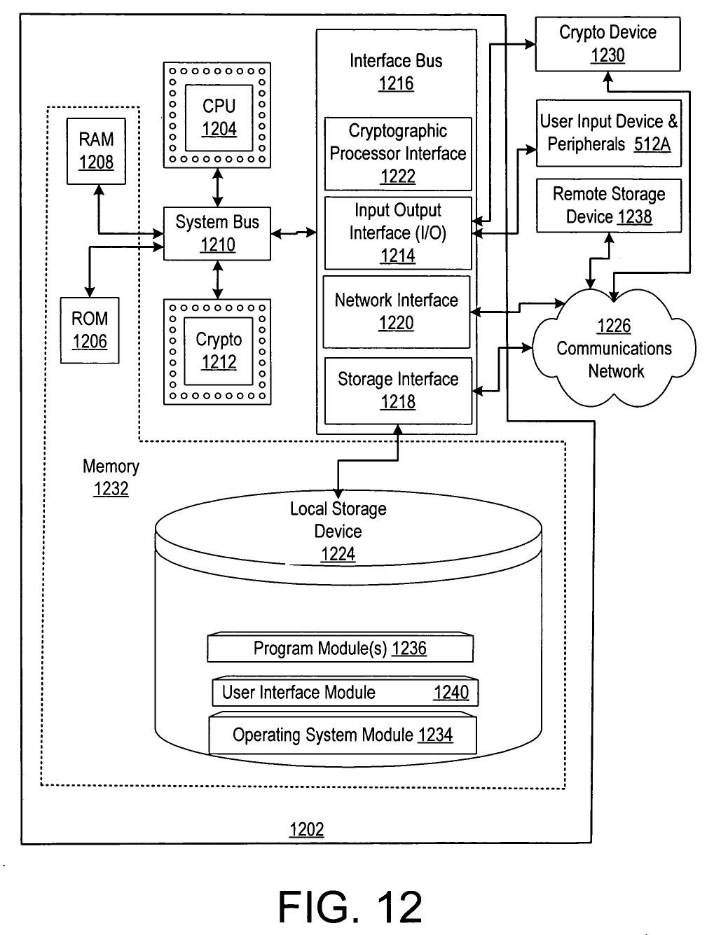

FIG. 12 is a representative generic example of a computer suitable for implementing some variants of the approach described herein.

In general, a suitable computer (1202) will comprise a central processing unit (CPU) (1204), a read only memory (ROM) (1206), a random access memory (RAM) (1208) most frequently, although not necessarily, all interconnected and/or communicating through a system bus (1210). Optionally, a cryptographic processor (1212) may also be connected to the system bus to implement or become part of an implementation of a security policy. Various components in the computer drive signals embodying information throughout the system. Such transmission and reception of signals embodying information throughout the computer may further be transmitted, received, and the causes of return and/or reply signal communications beyond the instant computer to: communications networks, input devices, other computers, peripheral devices and/or the like. Of course, any of the above components may be connected directly to one another, connected to the CPU (1204) and/or organized in the manner of any of numerous computer system variations.

The CPU (1204) comprises at least one high-speed data processor adequate to individually or in conjunction with other processors execute program modules for executing user and/or system-generated requests. The CPU (1204) may be a microprocessor such as AMD's Athlon, Duron and/or Opteron; IBM and/or Motorola's PowerPC; Intel's Celeron, Itanium, Pentium, Xeon, and/or XScale; and/or the like processor(s) or distributed processors such as are employed in various single instruction, multiple data SIMD or multiple instruction, multiple data MIMD type-computers. The CPU interacts with memory through signal passing through conductive conduits to execute stored program code according to conventional data processing techniques. Such signal passing facilitates communication within the system and beyond through various interfaces. Should processing requirements dictate a greater amount speed, further mainframe or super computer architectures or variants may similarly be employed. Alternatively, should deployment requirements dictate greater portability, smaller Personal Digital Assistants (PDAs) or other handheld units may be employed provided they have the requisite computing capability to accomplish their assigned task(s).

The power source for the computer can be of any standard form for powering small electronic circuit board devices such as the following power cells: alkaline, lithium hydride, lithium ion, nickel cadmium, solar cells and/or the like. Other types of AC or DC power sources may be used as well. In the case of solar cells, in one variant, the case has an aperture through which the solar cell may capture photonic energy to thereby provide electric current to the various components. In one example, an outside power source is alternatively provided through a connection across the I/O interface (1214), for example, a USB and/or IEEE 1394 connection, Such connections carry both data and power and are therefore a suitable source of power.

Interface bus(ses) (1216) may accept, connect, and/or communicate to a number of interface adapters, conventionally although not necessarily in the form of adapter cards, such as but not limited to: input output interfaces (I/O) (1214), storage interfaces (1218), network interfaces (1220), and/or the like. Optionally, cryptographic processor interfaces (1222) similarly may be connected to the interface bus (1216). The interface bus (1216) allows components of the computer to communicate with one another.

Storage interfaces (1218) may be present to accept, communicate, and/or connect to a number of storage devices such as, but not limited to: storage devices (1224) such as fixed or removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Optional network interfaces (1220) accept, communicate, and/or connect to a communications network (1226). Network interfaces may employ connection protocols such as, but not limited to: direct connect, Ethernet (thick, thin, twisted pair 10/100/1000 Base T, and/or the like), Token Ring, wireless connection such as IEEE 802.11a-x, and/or the like. A communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. For purposes of the above, the network interface may simply be regarded as a specialized form of an input output interface. Further, multiple network interfaces (1220) may be used to facilitate communication over various communications network types. For example, multiple network interfaces may be employed to allow for the communication over broadcast, multicast, and/or unicast networks. Similarly, wireless interfaces can be used to facilitate communication over a wireless network.

Input Output interfaces (I/O) (1214) accept, communicate, and/or connect to user input devices and/or peripheral devices (1228), cryptographic processor devices (1230), and/or the like. I/O (1214) may employ connection protocols such as, but not limited to: Apple Desktop Bus (ADB); Apple Desktop Connector (ADC); audio: analog, digital, monaural, RCA, stereo, and/or the like; IEEE 1394a-b; infrared; joystick; keyboard; midi; optical; PC AT; PS/2; parallel; radio; serial; USB; video interface: BNC, composite, digital, Digital Visual Interface (DVI), RCA, S-Video, VGA, and/or the like; wireless; and/or the like. A representative common output device is a video display, which typically comprises a Cathode Ray Tube (CRT) or Liquid Crystal Display (LCD) based monitor with an interface (e.g., DVI circuitry and cable) that accepts signals from a video interface (however any type of display, including plasma will work). The video interface composites information generated by the computer and generates video signals based on the composited information in a video memory frame. Typically, the video interface provides the composited video information through a video connection interface that accepts a video display interface (e.g., a DVI connector accepting a DVI display cable).

Optionally, if user input (1228) is to be allowed (for security or data manipulation purposes), one or more user input devices can be included. Such devices may be, depending upon the type of input to be allowed, card readers, dongles, finger print readers, gloves, graphics tablets, joysticks, keyboards, mouse (mice), trackballs, trackpads, retina readers, and/or the like.

Peripheral devices may be connected and/or communicate to I/O and/or other facilities of the like such as network interfaces, storage interfaces, and/or the like. Peripheral devices may be audio devices, cameras, dongles (e.g., for copy protection, ensuring secure transactions with a digital signature, and/or the like), external processors (for added functionality), goggles, microphones, monitors, network interfaces, printers, scanners, storage devices, video devices, visors, and/or the like. It should be noted that although user input devices and peripheral devices may be employed, variants may be embodied as an embedded, dedicated, and/or headless device, wherein access would be provided over a network interface connection.

Optionally, cryptographic units such as, but not limited to, microcontrollers, processors (1212), interfaces (1222), and/or devices (1230) can be included, and/or communicate with the system for security. By way of example, an MC68HC16 microcontroller, commonly manufactured by Motorola Inc., may be used for and/or within a representative cryptographic unit. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of a CPU. Other commercially available specialized cryptographic processors include VLSI Technology's 33 MHz (12868 or Semaphore Communications' 40 MHz Roadrunner 184.

Generally, any mechanization and/or embodiment allowing a processor to affect the storage and/or retrieval of information is regarded herein as memory (1232). Any of various forms of memory (1232) can be used individually or in combination. For example, the computer can be configured with and use on-chip CPU memory (e.g., registers), ROM (1206), RAM (1208), and a storage device (1224). The storage device (1224 )can be any conventional computer system storage. Storage devices may include a drum; a (fixed and/or removable) magnetic disk drive; a magneto-optical drive; an optical drive (i.e., CD ROM/RAM/Recordable (R), ReWritable (RW), DVD R/RW, etc.); and/or other devices of the like.

The memory (1232) may contain a collection of program and/or database modules and/or data such as, but not limited to: operating system module(s) (1234) (operating system) and those program module(s) (1236) necessary for implementing the instant approach, in whole or part. These modules may be stored and accessed from the storage devices and/or from storage devices accessible through an interface bus. Although non-conventional software modules such as those in the module collection, typically, are stored in a local storage device (1224), they may also be loaded and/or stored in memory such as: peripheral devices, RAM, remote storage facilities (1238) through a communications network (1226), ROM, various forms of memory and/or the like.

The operating system module (1234) is executable program code facilitating the operation of the computer. Typically, the operating system facilitates access of I/O, network interfaces, peripheral devices, storage devices and/or the like. The operating system may be a highly fault tolerant, scalable, and secure system such as Apple Macintosh OS X (Server), AT&T Plan 9, Be OS, Linux, Unix and/or the like operating systems. However, more limited and/or less secure operating systems also may be employed such as Apple Macintosh OS, Microsoft DOS, Palm OS, Windows 2000/2003/3.1/95/98/CE/Millenium/NT/XP (Server), and/or the like. The operating system will communicate to and/or with other modules, including itself. Most frequently, the operating system communicates with other program modules, user interfaces and/or the like. For example, the operating system may contain, communicate, generate, obtain and/or provide program module, system, user and/or data communications, requests and/or responses. The operating system, once executed by the CPU (1204), may enable the interaction with communications networks, data, I/O, peripheral devices, program modules, memory, user input devices, and/or the like. The operating system may provide communications protocols that allow the computer to communicate with other entities through a communications network (1213. Various communication protocols may be used by the computer as a subcarrier transport mechanism for interaction, such as, but not limited to: multicast, TCP/IP, UDP, unicast and/or the like.

A user interface module (1240) is stored program code that is executed by the CPU (1204). The user interface may be a conventional graphic user interface as provided by, with, and/or on top of operating systems and/or operating environments such as Apple Macintosh OS, e.g., Aqua, Microsoft Windows (NT/XP), Unix X Windows (KDE, Gnome, and/or the like), and/or the like. The user interface may allow for the display, execution, interaction, manipulation and/or operation of program modules and/or system facilities through textual and/or graphical facilities. The user interface provides a facility through which users may affect, interact and/or operate a computer system. A user interface may communicate to and/or with other modules in a module collection, including itself, and/or facilities of the like. Most frequently, the user interface communicates with operating systems, other program modules and/or the like. The user interface may contain, communicate, generate, obtain and/or provide program module, system, user and/or data communications, requests and/or responses.

It should be understood that the description herein is only representative of illustrative embodiments. For the convenience of the reader, the above description has focused on a representative sample of possible embodiments, a sample that is illustrative of the principles of the present invention. The description has not attempted to exhaustively enumerate all possible variations. That alternate embodiments may not have been presented for a specific portion of the invention, or that further undescribed alternate embodiments may be available for a portion, is not to be considered a disclaimer of those alternate embodiments. Other applications and embodiments can be straightforwardly implemented without departing from the spirit and scope of the present invention. It is therefore intended, that the invention not be limited to the specifically described embodiments, since numerous permutations and combinations of the above and implementations involving non-inventive substitutions for the above can be created, but the invention is to be defined in accordance with the claims that follow. It can be appreciated that many of those undescribed embodiments are within the scope of the following claims, and others are equivalent.

What is claimed is:

1. A computer aided method performed within a trading day for establishing secondary market-relevant price for a bond issued by a corporate entity, the method comprising:
accessing, using a computer, data relating to executed secondary market trades for a group of bonds issued by the entity, the group of bonds comprising at least a first set of bonds having a first maturity date and a second set of bonds having a second maturity date, the executed trades having occurred within a specified time period;
analyzing the data using the computer to select a subset of the information, the selection being based upon application of at least one specified criterion; and
using the subset, establishing an entity specific yield curve for the entity so that, using a bond pricing model, an anticipated price for the bond on the secondary market can be calculated using a point on the established entity specific yield curve that corresponds to the bond.

2. The method of claim 1 wherein the bond pricing model is an OAS-based pricing model.

3. The method of claim 1 wherein the information comprises a stream of reported market transactions.

4. The method of claim 3 wherein the stream of reported market transactions comprises data reported to the NASD pursuant to NASD Rule 6200.

5. The method of claim 1 wherein the information comprises an NASD Trade Reporting and Compliance Engine™ (TRACE) data feed.

6. The method of claim 1 wherein the specified time period is less than the time between the start of a day's trading and a then-present time.

7. The method of claim 1 wherein the specified time period is the smallest amount of time necessary to create yield curve data points for at least three different bonds of the entity.

8. The method of claim 1 wherein the specified time period is a moving window of time.

9. The method of claim 1 wherein the specified time period comprises, with respect to a trading day, at least one of:
i) between about trading start time and about mid-morning of the trading day;
ii) between about mid-morning and about mid-day of the trading day;
iii) between about mid-day and about mid-afternoon of the trading day; or
iv) between about-mid afternoon and late-afternoon of the trading day.

10. The method of claim 1 wherein the establishing the entity specific yield curve for the entity comprises:
for all trades in the subset corresponding to the first maturity date, calculating a median first bond price.

11. The method of claim 10 further comprising, for all trades in the subset corresponding to the second maturity date, calculating a median second bond price.

12. The method of claim 1 wherein the establishing the entity specific yield curve for the entity comprises:
for all trades in the subset corresponding to the first maturity date, calculating a mean first bond price.

13. The method of claim 12 further comprising, for all trades in the subset corresponding to the second maturity date, calculating a mean second bond price.

14. The method of claim 1 wherein the establishing the entity specific yield curve for the entity comprises:
for all trades in the subset corresponding to the first maturity date, calculating a volume weighted average first bond price.

15. The method of claim 14 further comprising, for all trades in the subset corresponding to the second maturity date, calculating a volume weighted average second bond price.

16. The method of claim 1 wherein the establishing the entity specific yield curve for the entity comprises:
fitting a curve to pricing data associated with the subset using a cubic spline interpolation technique.

17. The method of claim 1 wherein the bond for which the anticipated price can be calculated has not traded on the secondary market since a time prior to an immediately preceding trading day.

18. A computer implemented method for establishing a price for a bond of a particular entity, the method comprising, using a programmed processor to:
access data reflecting trades of commercial entity-issued bonds, the data comprising trades of bonds issued by the particular entity;
identify trades specific to bonds of the particular entity;
interpolate a yield curve for the entity based upon applying a cubic spline algorithm to points for each of the traded bonds issued by the particular entity;
identify an MCAA-Yield for the bond for which the price will be established using the yield curve; and
calculate the price for the bond by using the MCAA-Yield and information specific to the bond in an OAS-based bond pricing model.

19. The computer implemented method of claim 18 wherein the bond for which the price is calculated will have not been traded on a secondary market for a specified period of time.

20. The computer implemented method of claim 18 wherein the programmed processor is configured to interpolate the yield curve by a calculation comprising, for each unique bond maturity, the points using at least one of:
a) a volume weighted average;
b) a volume weighted average preceded by exclusion of odd lot trades;
c) a time stamped volume weighted average that gives greater weight to trades having a more recent time stamp;
d) a time window based volume weighted average;
e) an unweighted statiatically based calculation;
f) a tolerance based mean trade level analysis;
g) a time stamped tolerance based mean trade level analysis; or
h) a time window based, and tolerance based, mean trade level analysis.
